(19) United States
(12) Patent Application Publication
(10) Pub. No.: US 2008/0301685 A1
(43) Pub. Date: Dec. 4, 2008

(54) Identity-aware scheduler service

(75) Inventors: Kasman E. Thomas, Wilton, CT (US); Lyndon A. Washington, Oxford, CT (US)

Correspondence Address: KING & SCHICKLI, PLLC, 247 NORTH BROADWAY, LEXINGTON, KY, 40507, US

(73) Assignee: Novell, Inc.

(21) Appl. No.: 11/809,300

(22) Filed: May 31, 2007

(51) Int. Cl. G06F 9/46; G06Q 20/00; H04L 9/32

(52) U.S. Cl. 718/102; 705/44; 726/5

(57) ABSTRACT

In a computing environment, clients and scheduling services are arranged to coordinate time-based services. Representatively, the client and scheduler engage in an http session whereby the client creates an account (if the first usage) indicating various identities and rights of the client for use with a scheduling job. Thereafter, one or more scheduling jobs are registered including an indication of what payloads are needed, where needed and when needed. Upon appropriate timing, the payloads are delivered to the proper locations, but the scheduling of events is no longer entwined with underlying applications in need of scheduled events. Monitoring of jobs is also possible as is establishment of appropriate communication channels between the parties. Noticing, encryption, and authentication are still other aspects as are launching third party services before payload delivery. Still other embodiments contemplate publishing an API or other particulars so the service can be used in mash-up applications.

### FIELD OF THE INVENTION

Generally, the present invention relates to computing system environments and products involved with time-based events, such as workflow systems and enterprise applications in need of job-scheduling. Particularly, it relates to methods and systems for scheduling time-based services, according to client identity. In this regard, a scheduling solution, decoupled from underlying applications in need of scheduling services, is usable across an enterprise (or beyond), by client applications written in any language, on various computing machines in diverse environments, with flexibility as to communication protocols. Various features relate to account creation, job registration, payload delivery, computing arrangements and computer program products. Monitoring jobs, establishing communication channels, noticing, encryption, authentication, and mash-up applications are other noteworthy features, to name a few.

### BACKGROUND OF THE INVENTION

In workflow systems, enterprise applications, or anywhere a time-based reminder is needed (e.g., calendaring functions), there have been long felt needs for job-scheduling. While many implementations exist for setting timer functions, scheduling jobs, etc., many are hard-wired or coupled directly with underlying applications, which unduly entangles the scheduling with the application in need of the scheduling. Adverse programming side effects are the result upon evolution of the application, including, but not limited to, needing to constantly revisit and rework the code for job scheduling as the application evolves.

Also, code for job scheduling that is entangled with an application is unable to find utility in other applications. That is, the code is often so embedded in the application that others cannot find it readily or exploit it. This makes code reuse impractical thereby complicating scheduling functionality. Code entanglement is also an issue in that system administrators, users, etc., are unable to monitor progression of scheduling events for various purposes. Similarly, code entanglement inhibits use with other evolving technologies, such as service buses, public-facing APIs, bulletin boards, or the like.

While there exist certain general-purpose job-scheduler libraries and APIs (including open-source ones like Quartz, available at http://www.opensymphony.com/quartz, for instance) that can be made available on a Java classpath or run inside a container on an application server, etc., so that more than one application can use the same scheduler code, they fail in purpose because the machine that hosts the scheduler code may not be the machine that runs the various enterprise applications that need access to the scheduler. Even if a scheduler can be accessed remotely via RMI, CORBA, etc., the client must rely on the remote host being operational, with sufficient connections available, etc. High availability becomes a nontrivial consideration. Also, remote debugging and error notification are concerns.

Moreover, enterprises rely increasingly on compliance-aware (or “governanced”) provisioning systems for managing user privileges and entitlements. These systems often have policy-driven recurrence requirements. For example, a user may be required to change his or her password every 30 days, or she or he may be required to renew a group membership every 90 days, etc.

Accordingly, a need exists in the art of time-based scheduling for a service uncoupled from underlying applications to avoid unnecessary entanglement. In turn, the service should be usable across an enterprise, by client applications written in any language, on various machines in diverse environments, with flexibility as to communications protocols. Such should also embrace governance scenarios, while simultaneously enabling code reuse, integration with multiple applications and evolving technologies, and monitoring and noticing capabilities. Naturally, any improvements along such lines should further contemplate good engineering practices, such as relative inexpensiveness, stability, ease of implementation, low complexity, security, unobtrusiveness, etc.

### SUMMARY OF THE INVENTION

The above-mentioned and other problems become solved by applying the principles and teachings associated with the hereinafter-described identity-aware scheduling service. Techniques and computing arrangements include, in a basic sense, an enterprise-grade scheduling solution usable across an enterprise, or beyond, by client applications written in any language, on various computing machines in diverse environments, with flexibility as to communication protocols. During use, clients create accounts with the scheduling service and register scheduling jobs in order to accomplish time-based tasks, without unnecessarily entangling the tasks with underlying or other applications having need of the task. Upon reaching the appropriate time, the scheduling service delivers necessary payloads to recipients at locations indicated with the registered job. In this manner, separation of functionality exists between applications and scheduling so that multiple applications, in high availability, can use the same scheduler code. Intuitively, this adds robustness and economic and computing costs are downplayed while physical and hacking security is enhanced.

In one embodiment, methods and computing systems include a client and scheduling service arranged together for scheduling time-based services. Representatively, the client and scheduling service engage in an http session whereby the client creates an account (if the first usage) indicating various identities and rights of the client for use with a scheduling job. Thereafter, scheduling jobs are registered with the scheduling service including an indication of what payloads are needed, where payloads are needed and when they are needed. Upon the arrival of the appropriate time, the payloads are delivered to the proper locations. In this manner, scheduling of events is bifurcated from the underlying applications in need of scheduled events. Monitoring of registered jobs is another function as is establishing the appropriate communication channels between the client and the scheduling service and third parties, if any. Noticing, encryption, and authentication are other aspects as are launching third party services before payload delivery. Still other embodiments contemplate publishing necessary information about the scheduling service, such as the API, so it can be used in mash-up applications.

Regardless of form, the foregoing contemplates a system for exposing a scheduling service as part of a Services Oriented Architecture (SOA). Features include, but are not limited to: 1) a runtime implementation (opaque to clients except for a public API) that runs on one or more host machines; 2) a manner of expressing, in a standardized document (e.g., WSDL), all of the runtime's available modes of communication, its functional capabilities, its quality-of-service capabilities, and its actual API; 3) a discovery mechanism (e.g., WSIL or UDDI) to make the aforementioned document (and therefore the service's capabilities, API, etc.) discoverable by remote clients; 4) a mechanism to allow publishing events about the scheduled tasks to a message queue (which MAY be a JMS or MOM queue/topic, or MAY also be an RSS/Atom server) such that an administrator or other appropriately qualified user can monitor a “feed” (using standard RSS feed aggregation tools) as a way of tracking events; 5) a capability for clients to call the scheduler service with arbitrary application data expressed as XML, where it will be cached for later use: for example, a workflow can send state data to the service, and the service will store that data in a data store until the next scheduled job event, then send the data back to the client; 6) a way to allow application data confidentiality, data exchange integrity and client/server control access and authorization through the utilization of WS-Security and XML encryption; 7) a registration mechanism to enforce authorizations for clients to submit scheduler jobs to the scheduler service, query the state of stored data and jobs and provide some level of job administration; 8) a multiple tier authorization and registration mechanism—the first level of which would allow some identifier that was created at registration time to be used as an authentication credential to allow any party presenting the credential to gain access to the job-monitoring feeds or other events; 9) a method for a scheduling client to handle the authentication and creation of tokens, where the token would be the embodiment of established assertions about the authorizations that the scheduling client has defined for the authenticated user; 10) making job scheduling amenable to governance; 11) enabling a process-agnostic scheduler to parse user data (via, for example, XPath) at user-specified times in the future, and thereby be able to send meaningful messages to various addresses at various times via various protocols; and 12) using existing web standards to make a scheduling system web-friendly, and thus usable in mash-up or other applications.

Still other embodiments contemplate computer program products with executable instructions, available as a download or on a computer-readable media, for implementing some or all of the foregoing on one or more computing devices.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a representative computing system environment for an identity-aware scheduling service;

FIG. 2 is a high-level flow organization in accordance with the present invention for an identity-aware scheduling service;

FIG. 3 is a flow chart in accordance with the present invention for representative creation of a scheduling service account;

FIG. 4 is a diagrammatic view in accordance with the present invention for representatively indicating identities and rights in an identity-aware scheduling service;

FIG. 5 is a diagrammatic view in accordance with the present invention of one representative instance of determining communication channels between parties associated with an identity-aware scheduling service;

FIGS. 6A-6G are diagrammatic views in accordance with the present invention of representative alternate instances of determining communication channels between parties associated with an identity-aware scheduling service;

FIG. 7 is a flow chart in accordance with the present invention for representatively registering a scheduling job with an identity-aware scheduling service;

FIG. 8 is a flow chart in accordance with the present invention for representatively delivering a payload to a location indicated with a registered scheduled job;

FIGS. 9A-15 are diagrammatic views in accordance with the present invention of representatively delivering a payload to a recipient at a location indicated with a registered scheduled job; and

FIG. 16 is a flow chart in accordance with the present invention for representatively mashing-up an identity-aware scheduling service.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus for an identity-aware scheduling service are hereinafter described.

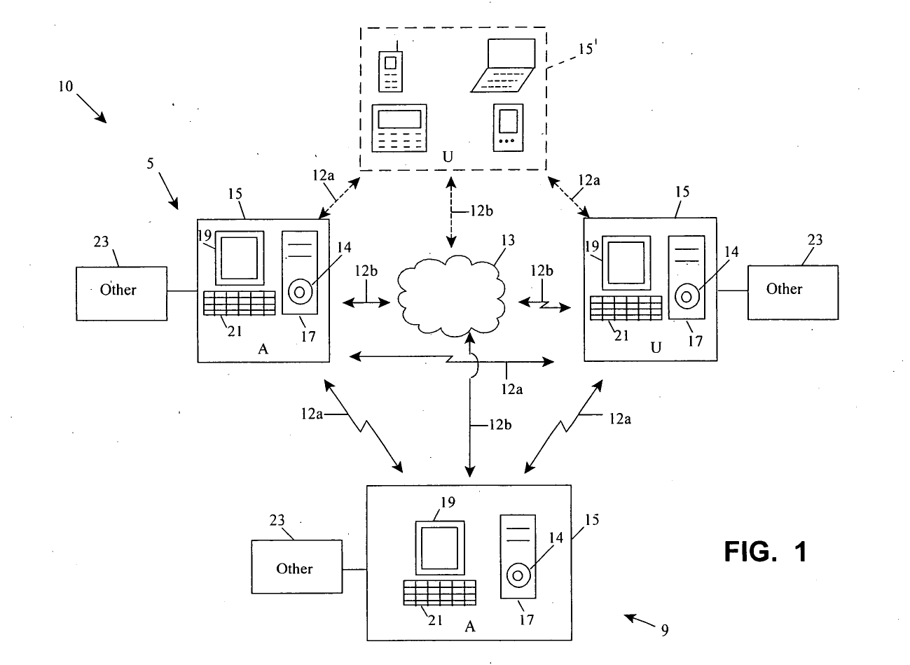

With reference to FIG. 1, a representative environment 10 for the identity-aware scheduling service includes one or more computing devices 15 or 15′ available per each of a client 5, a scheduling service 7 or a third party 9. In a traditional sense, an exemplary computing device exemplifies a server 17, such as a grid or blade server, or peer-to-peer arrangement, hosting applications, web functions, communications, files, etc. Alternatively, an exemplary computing device includes a general or special purpose computing device in the form of a conventional fixed or mobile computer 17 having an attendant monitor 19 and user interface 21. The computer internally includes a processing unit for a resident operating system, such as DOS, WINDOWS, MACINTOSH, VISTA, UNIX and LINUX, to name a few, a memory, and a bus that couples various internal and external units, e.g., other 23, to one another. Representative other items 23 (also available per each of the client, scheduling service and third party) include, but are not limited to, PDA's, cameras, scanners, printers, microphones, joy sticks, game pads, satellite dishes, hand-held devices, consumer electronics, minicomputers, computer clusters, main frame computers, a message queue, a peer machine, a broadcast antenna, a server (web, application, communication, file, etc.), an AJAX client, a grid-computing node, a peer, a virtual machine, a web service endpoint, a cellular phone or the like. The other items may also be stand alone computing devices 15′ in the environment 10.

In either, storage devices are contemplated and may be remote or local. While the line is not well defined, local storage generally has a relatively quick access time and is used to store frequently accessed data, while remote storage has a much longer access time and is used to store data that is accessed less frequently. The capacity of remote storage is also typically an order of magnitude larger than the capacity of local storage. Regardless, storage is representatively provided for aspects of the invention contemplative of computer executable instructions, e.g., code or software, as part of computer program products on readable media, e.g., disk 14 for insertion in a drive of computer 17. Computer executable instructions may also be available as a download or reside in hardware, firmware or combinations in any or all of the depicted devices 15 or 15′.

When described in the context of computer program products, it is denoted that items thereof, such as modules, routines, programs, objects, components, data structures, etc., perform particular tasks or implement particular abstract data types within various structures of the computing system which cause a certain function or group of functions. In form, the computer product can be any available media, such as RAM, ROM, EEPROM, CD-ROM, DVD, or other optical disk storage devices, magnetic disk storage devices, floppy disks, or any other medium which can be used to store the items thereof and which can be assessed in the environment.

In network, the computing devices communicate with one another via wired, wireless or combined connections 12 that are either direct 12a or indirect 12b. If direct, they typify connections within physical or network proximity (e.g., intranet). If indirect, they typify connections such as those found with the internet, satellites, radio transmissions, or the like, and are given nebulously as element 13. In this regard, other contemplated items include servers, routers, peer devices, modems, T1 lines, satellites, microwave relays or the like. The connections may also be local area networks (LAN) and/or wide area networks (WAN) that are presented by way of example and not limitation. The topology is also any of a variety, such as ring, star, bridged, cascaded, meshed, or other known or hereinafter invented arrangement.

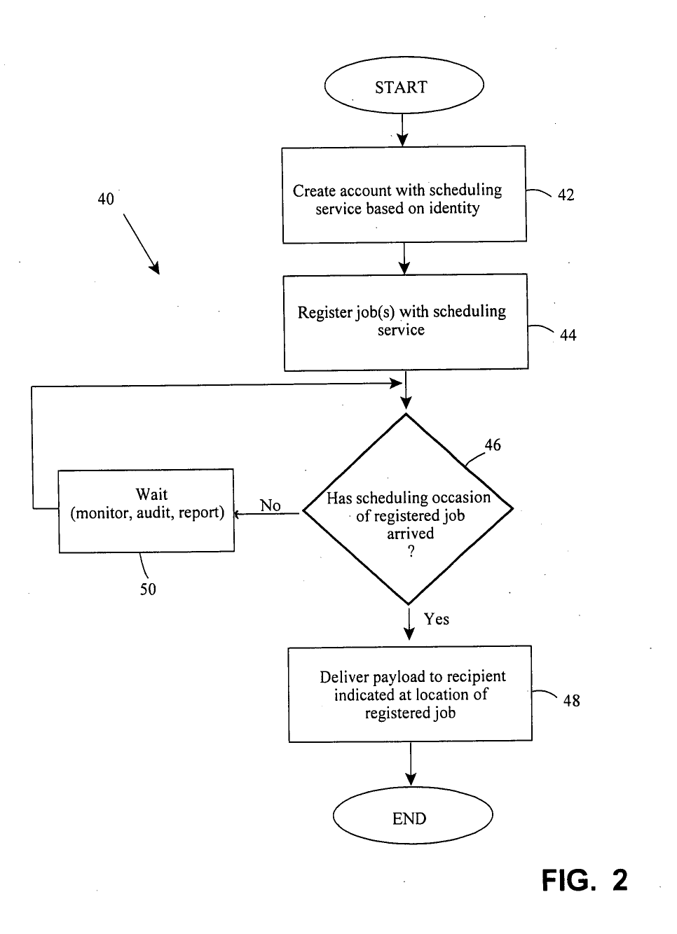

With the foregoing representative computing environment as a backdrop, FIG. 2 shows a high-level organization 40 for the general pattern of usage for scheduling job services, between a client, a scheduling service and various third parties, if any. In particular, step 42 contemplates the creation of a client account with a scheduling service based on one or more identities of the client, and their attendant rights. In form, the identities can represent a workflow instance, a process instance of some kind, a human user (such as a person in an enterprise, e.g., system administrator, manager, employee, etc.), a proxy or other known or later invented identity. The account itself may be of the type whereby one creation is required per all later tasks or of the type whereby one creation is required per each later task, or variations thereof. Also, the account may be free or require various licensing payments.

At step 44, a time-based scheduling job is registered with the scheduling service. As before, this contemplates the avoidance of entanglement between the registered job and whatever underlying application or other service may need the tasks associated with the job. As a working example, later described in detail, a registered job might consist of a user notification of imminent password expiration at 60, 75, and 89 days, in time to renew registration before password expiration on the 90th day relative to a workflow designed to give the user access to an Oracle database, but having a predetermined policy requiring the user renew his account every 90 days. In this regard, the registered job of password notification is decoupled from the underlying user access to the database and its contents. In turn, the scheduling service will provide the appropriate notices to the user on the specified days, and it too will avoid unnecessary entanglement with the underlying user access to the database and its contents. In other words, the service to give notice to the user is bifurcated from the actual application giving user access to the database. In turn, the avoidance of entanglement yields separation of tasks enabling the afore-mentioned advantages of enterprise-wide access, or beyond, for applications of clients 5 (FIG. 1) written in any language, on various machines in diverse environments, with flexibility as to communications protocols. Such also embraces governance scenarios (as with the 90 day limitation on user accounts), while simultaneously enabling code reuse, integration with multiple applications and evolving technologies, monitoring and noticing capabilities, or the like, as will become apparent below. Naturally, skilled artisans will be able to contemplate other scenarios of registered jobs, and underlying applications to which they have applicability.

In order for the scheduling service to know where user notices are to be sent (e.g., a URI or URL endpoint, such as an http address, perhaps, and such may be different or the same as the location of the client), what type of information is required to notify the user (e.g., a payload, such as a statement of password expiration in 30, 15 or 1 days from now relative to the Oracle database account), and when such notices are needed (e.g., at the 60^{th}, 75^{th} and 89^{th} days), the registration of the scheduling job further contemplates the providing of this information from the user to the scheduling service as part of the job registration. For this, various web pages of questions, for example, are provided to the client on the monitors of their respective computing devices. Then, once provided, the scheduling job is completely registered with the scheduling service. To the extent more than one scheduling job is required, clients will be able to register multiple jobs together or re-access their account in the future to add more. They may even cancel jobs, rearrange priorities, modify existing jobs, or other, provided, of course, their identity enables such functionality.

At step 46, it is then determined by the scheduling service whether the scheduling occasion of the registered job has arrived. If so, the payload is delivered to the location indicated with the registered job, step 48. Alternatively, the scheduling service does not provide a payload, but simply pings the location indicated with the scheduling job so the appropriate recipient can go and retrieve the payload. Still alternatively, the client can ping or contact the scheduling service and order the scheduling service to send the payload.

If, on the other hand, the scheduling occasion of the registered job has not arrived, the determining process 46 is later attempted after an appropriate amount of time elapses, step 50. During this time, an optional step of monitoring the progress of the requested job can occur, such as by one or more of the identities of the client account monitoring feeds according to one or more various rights allocated per their identity. In other optional steps, user identities may obtain reports/logs on the progress of in-flight or existing jobs or be able to receive/create audits of same. Eventually, however, the time occasion of the registered job will come to pass and the payload will be delivered to the appropriate recipient.

Appreciating the above, password-expiration scenario may lend itself to a user actually responding to the first reminder, the removal of future or remaining reminders creates opportunity for another scenario. Namely, a periodic attestation scenario provides that after assigning access to a resource, the entity of the client is that which receives the payload at step 48. In turn, appropriate entity personal, such as a manager, attests that one or more clients still need access to the resource. In this manner, the registered job invokes a new workflow and supplies the details about the resource, employee who has access to the resource, based on the information stored at step 44, for instance.

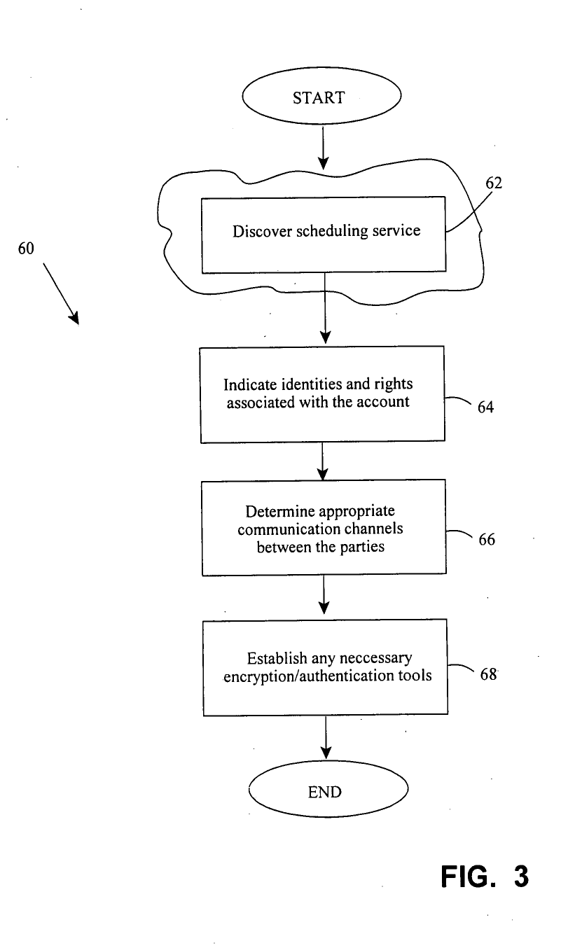

Detailing the high-level process of identity-aware scheduling services, FIG. 3 teaches a representative account creation 60 by a client. Beforehand, however, it is to be appreciated that the client first need know of the scheduling service to use it, or be able to find or discover it without first knowing of it, step 62. For this, a runtime implementation of the scheduling service is envisioned that runs on one or more host computing devices 15 (FIG. 1) and is generally opaque to clients except for a public API (described below). In expression, a standardized document (e.g., WSDL), is contemplated for all of the runtime's available modes of communication, its functional capabilities, its quality-of-service capabilities, and its actual API. In turn, the discovery mechanism (e.g., WSIL or UDDI) makes the document (and therefore the scheduling service's capabilities, API, etc.) discoverable by remote clients who do not know of its existence.

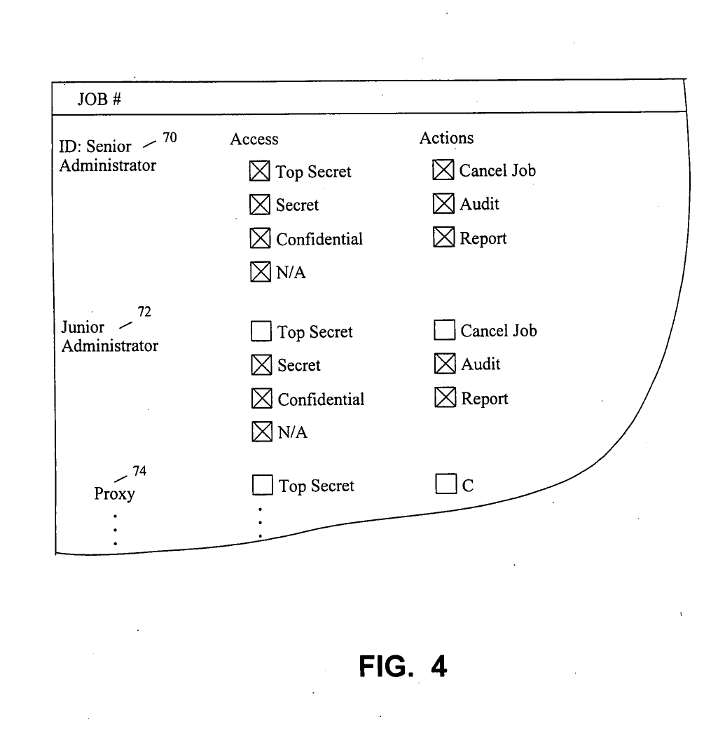

Once discovered, the identities of the client account, and their attendant rights, are made known to the scheduling service, step 64. For this, FIG. 4 contemplates a variety of mechanisms available on a monitor of a computing device, such as actual names of particular identities 70, 72, 74 and attendant associations, e.g., x's in boxes , for indicating their rights. As seen, a senior administrator can see (monitor) all types of jobs (top secret, secret, confidential, N/A) and perform all actions (cancel job, audit job, and obtain reports). A junior administrator 72, on the other hand, cannot see all jobs (not the top secret jobs) and cannot perform all actions (cannot cancel jobs). Of course, this is only representative and skilled artisans will easily be able to contemplate other identities and other rights for use therewith.

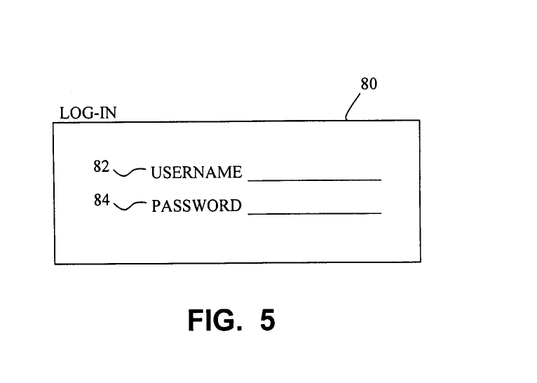

Returning to FIG. 3, the creation of a client account further includes the possibility of determining appropriate communication channels between the parties, step 66, especially channels between the client, the scheduling service and third parties, if any. Representatively, this includes the notion of how the scheduling service will know or authenticate various identities of the client, such as by proper identification credentials 80, e.g., a username 82 and password 84 in FIG. 5. It is anticipated that the identification could be arranged as an “authenticate once” for an all access pass of registered jobs or an “authenticate once per each instance of performing an act or function.” This can also be tied to levels of identities, such that superior identities (e.g., senior administrator 70, FIG. 4) need to authenticate often per function whereas inferior identities (e.g., junior administrator 72, FIG. 4) need not authenticate but once. Of course, other authentication scenarios are embraced and readily imagined.

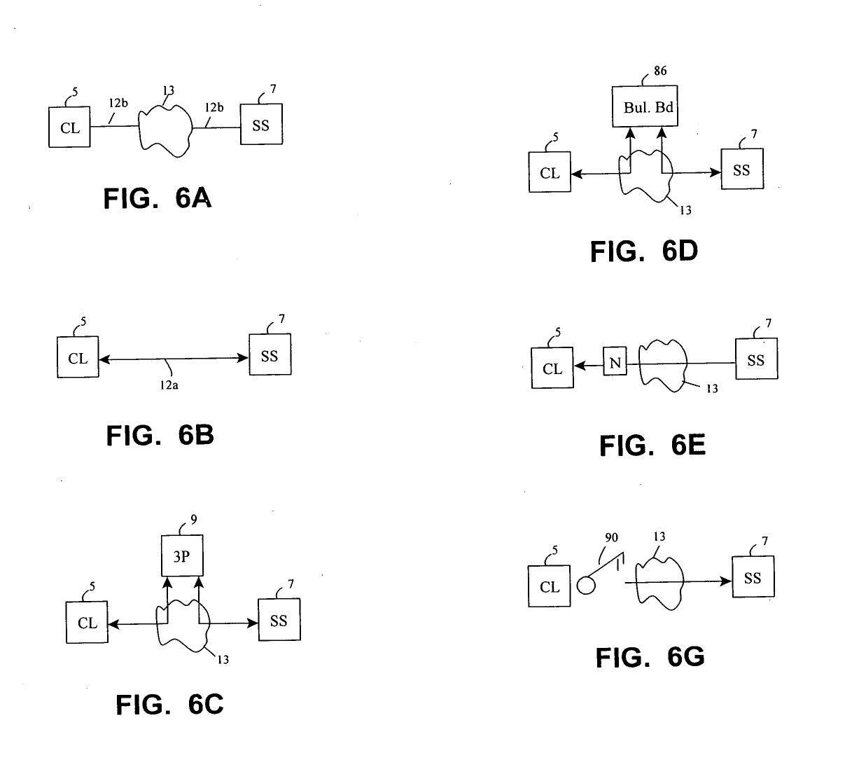

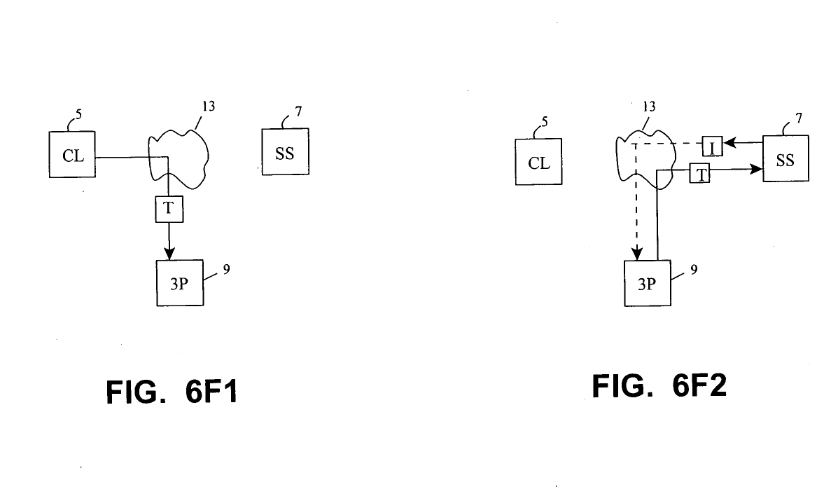

Additionally, the establishment of communication channels (step 66, FIG. 3) contemplates the many embodiments of FIG. 6A-6G, individually or as mixed-and-matched combinations with one another or in combination with other known or later-invented channels. It further includes the notion of actually specifying the channel between the parties or just taking advantage of existing technologies, and enabling such to happen, without expressly communicating it between the parties.

In particular, FIGS. 6A and 6B contemplate a communication channel between a client (Cl) 5 and a scheduling service (SS) 7 that exists over indirect connections 12b, via 13, or as direct connections 12a, as similarly illustrated in FIG. 1.

Alternatively, FIG. 6C shows clients 5 and scheduling services 7 communicating with one another solely by way of an intermediate third party (3P) 9. As envisioned, each of the client or scheduling service transmits to the third party, in the blind or clear, and the third party re-transmits to the other of the scheduling service or the client, in the blind or clear. In this way, anonymity and/or enhanced security is garnered in the relationship. It is even contemplated that the third party is known to at least one of the client or scheduling service and is agreed upon for use upon selection in advance or on the fly by one or both of the client and the scheduling service. Alternatively, the communications by way of the third party may be only known to either the client or scheduling service, but not both. Alternatively still, a third party can be a trusted party, an impartial or biased party, a secret party, a surreptitiously-used party, or other.

In FIG. 6D, it is contemplated that communications will exist between the client and scheduling service by way of an electronic bulletin board 86, designated to encompass known bulletin boards, message busses, message queues, or the like. With such, a client identity monitors existing or “in-flight” scheduling jobs and/or visits the board when notified with an alarm. Existing technology or standards are leveraged, thereby providing a clean abstraction between the parties which reinforces notions of their individual contractual obligations. For instance, a clean abstraction between the parties allows publishing events at the bulletin board regarding the scheduled jobs or tasks (which MAY be a JMS or MOM queue/topic, or MAY also be an RSS/Atom server) such that an administrator 70, 72 or other appropriately qualified identity can monitor a “feed” on the connections thereof (using standard RSS feed aggregation tools) as a way of tracking events.

In conjunction with FIG. 6D, or independently, a noticing function N is envisioned in FIG. 6E whereby the scheduling service 7 provides the client 5 with alarms, emails, or other notices. The notices serve to inform the client of particulars of a registered scheduled job, generalities about any or all scheduling jobs, or prod the client to respond to requests or take action on a job, as the case may be. Naturally, the notices N can be of other varieties and content.

Returning back to FIG. 3, another component of creating an account is that of establishing any necessary encryption or authentication tools, step 68, such as by passing keys or developing tokens. In this manner, a paradigm for trust propagation between the parties is envisioned. For instance, encryption tools may be keys that the scheduling service needs to communicate with the client or simply keys that need passing to a third party recipient of a payload, but need to be recognized as keys by the service. Authentication tools, on the other hand, may be tokens or other certificates that the client presents to the service in order to communicate with the service. The authentication tools may also be passed to third parties so the third party stands in the shoes of the client. Stated differently, whichever party bears the token or certificate to the service gets whatever privileges are associated therewith.

As a diagrammatic example of each, FIGS. 6F1 and 6F2 show the notion of certificate or token T being passed and presented, while FIG. 6G teaches keys. As seen in FIGS. 6F1 and 6F2, a token T (established at step 68 (FIG. 3)) is first passed from the client 5 to a third party 9, where it is then passed to the scheduling service 7. In turn, the scheduling service recognizes the third party as a proper recipient of interaction with the service and, by proxy, receives or monitors information I about scheduling jobs in a manner in which the client would otherwise receive or monitor it. Also, the token itself can serve as indicating the sole recipient of job scheduling information or can serve as the only qualified recipient in addition to the original client 5. Alternatively still, the token can be a tool passed from still another third party (not shown) or created by the scheduling service and pushed to the client or others. Thus, the notion of tokens or authentication is not limited to any one party configuring the mechanics thereof, but is intended to provide a mechanism whereby the scheduling service communicates with or is monitored by an appropriate party with an appropriate set of rights. Of course, other paradigms are possible and skilled artisans will readily understand them.

In FIG. 6G, the diagram reflects the notion that a key 90 can be given to the scheduling service 7 from the client 5. Alternatively, keys can be given to both the client and scheduling service from third parties or the scheduling service can push a key onto the client. Regardless, the key can be used to decrypt the exchange of information between the client and scheduling service, and/or the key can simply be a tool that the scheduling service needs to pass along to a recipient of the payload, if different from the client, so the recipient can decrypt a contents of the payload. Under this latter scenario, the functionality of key may or may not be kept from the scheduling service, such that the scheduling service will have access to or will be prevented from understanding or realizing a content of the underlying payload. Of course, skilled artisans will envision other scenarios.

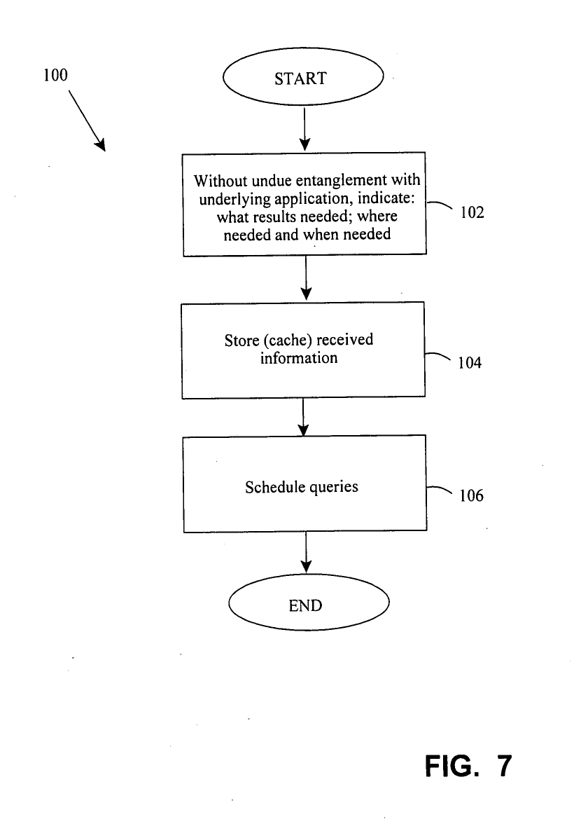

With reference to FIG. 7, a more detailed process of the registering of scheduling jobs between a client and a scheduling service is given generically as 100. At step 102, the client registers a scheduling job by indicating what results are needed, when they are need and at what location (or where) they are needed. They also register them without unduly entangling the job with the underlying application or service in need of the scheduling service, as before.

For the what-results needed component (payload), the client indicates items necessary for the task. Continuing with the previous example, this may consist of providing a “statement” to a user of an Oracle database that their password registration is imminently set to expire. It may also consist of providing an actual compilation of data, code, correspondence or other “content” that the client informs the scheduling service needs to be delivered to a party at a specific time. As an example, an underlying software application may have limited storage capabilities unable to locally store genome sequencing information. But, at a particular point in time, such as after processing a DNA sample, the software application may desire to download or obtain the genome sequencing information for comparison to the sample. Thus, the client may deliver the future-needed genome sequencing information that gets provided back to the software application upon the time instance of completing processing on the DNA sample. In that an infinite number of examples are possible as representative scenarios for this step, the foregoing is only to be construed as representative, and not limiting.

For the when-needed component of the job scheduling, timing data can consist of: 1) a precise instance of time, e.g., 12:01 a.m. on Saturday, Feb. 4^{th}, 2008; 2) a window or interval of time, e.g., between Saturday and Tuesday of this week; or 3) an endpoint-conditioned occasion of time, e.g., no later than [or no earlier than] 4:00 p.m. today, to name a few. Alternatively, instances of time can be specified in multiples. For instance, the previous password expiration example contemplated providing a user-statement at the 60^{th}, 75^{th}, and 89^{th} days, in time for renewing a password before the 90th day. Thus, multiple instances of time can be any of multiple instances of items 1), 2) or 3) above or set as “every x number of . . . ” minutes, hours, days, years, etc. Alternatively still, the timing data can be created as an algorithm, code, heuristically or in other manners not actually specifying time, per se, and all can be established by either the client or the scheduling service, or both, or another party.

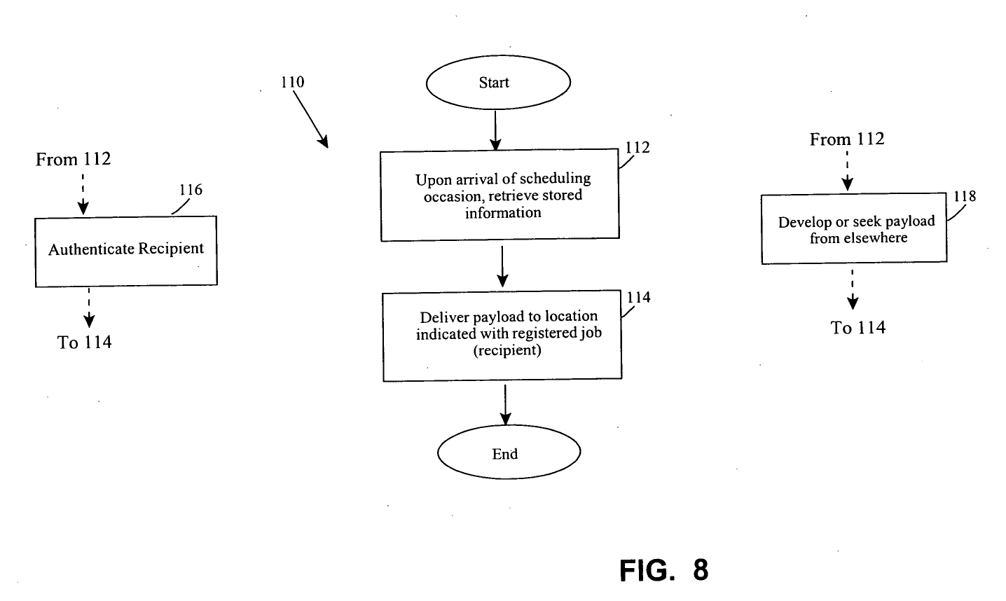

For the where-needed component of the job scheduling, the client indicates a location, such as a URI or URL address, an email address, or the like. More narrowly, the location may be a precise location within an underlying application of code in need of the scheduling service. The location may also be found at multiple places or single places, and have multiple or single delivery of payloads at either. For actual delivery of the payload to the location(s), representative examples will be provided in relation to FIGS. 8-15.

At step 104, that which the client indicates or sends to the scheduling service needs to be stored or cached for later retrieval. It is contemplated that clients will call the scheduling service with arbitrary application data expressed as XML, where it will be cached for later use: for example, a workflow can send state data to the service, and the service will store that data in a data store until the next scheduled job event, then send the data back to the client or other recipient. Preferably, this would be made available through a WS-Addressing compatible API, since WS-Addressing provides a way to perform asynchronous invocation and callback.

Finally, at step 106, queries are scheduled by the scheduling service so that the registered job will receive the scheduling services it requests. For example, and continuing the earlier password expiration example, the scheduling service schedules queries to ensure that the statements to a user are indeed sent at the 60^{th}, 75^{th}, and 89^{th} days, in time for renewing a password before the 90th day. Of course, other examples are within the scope of the invention.

With reference to FIG. 8, a more detailed process of delivering of a payload to the location indicated with a registered job is given generically as 1 10. At step 102, the scheduling service retrieves that which was previously stored (e.g., step 104, FIG. 7) and does so when the scheduling occasion has arrived, is about to arrive or is requested. Thereafter, the payload is delivered to the location indicated with the scheduling job, step 114. For this, many embodiments are contemplated.

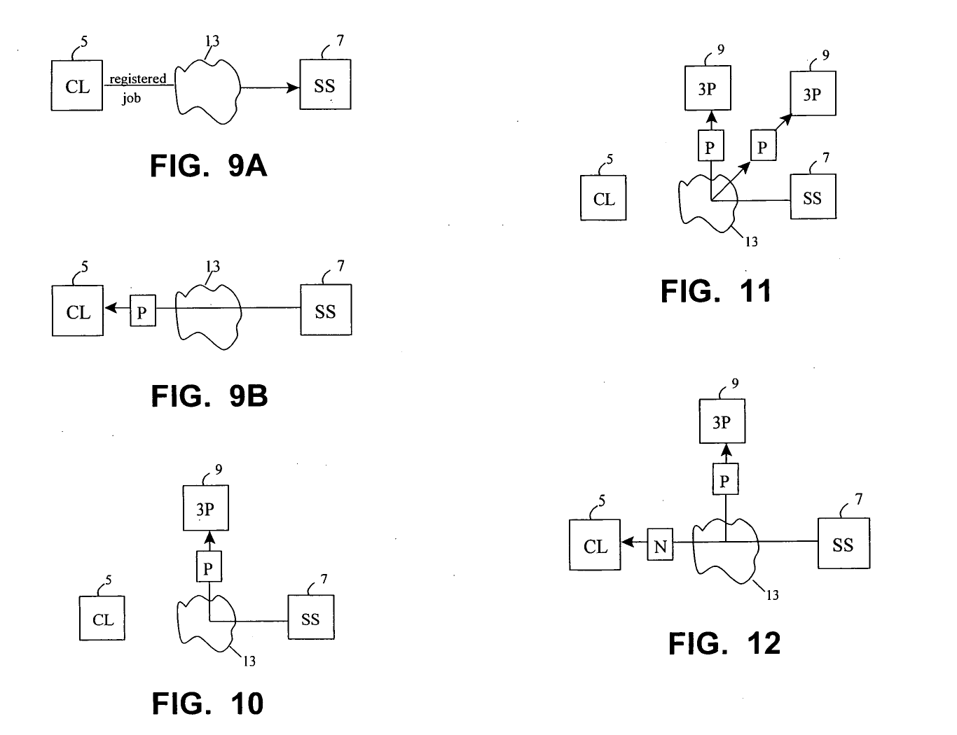

In FIG. 9A, a client 5 registers the scheduling job with the scheduling service 7 and FIG. 9B shows the scheduling service delivering the payload P back to the client. In FIG. 10, however, the payload P is not delivered back to the client, but to a third party 9. In FIG. 11, the payload goes to multiple third parties. In FIG. 12, while the payload P may go to a third party 9, a noticing function N goes back to the client to indicate confirmation of the payload delivery.

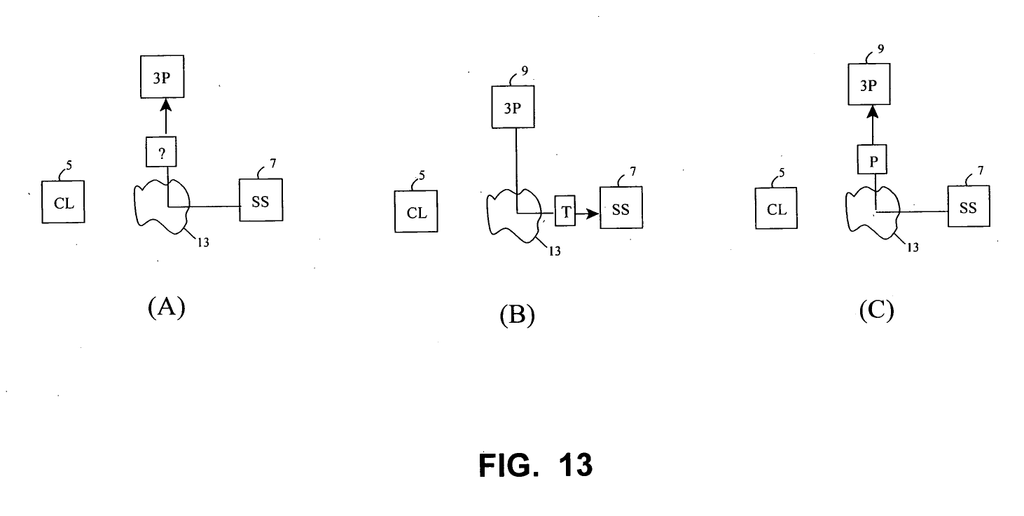

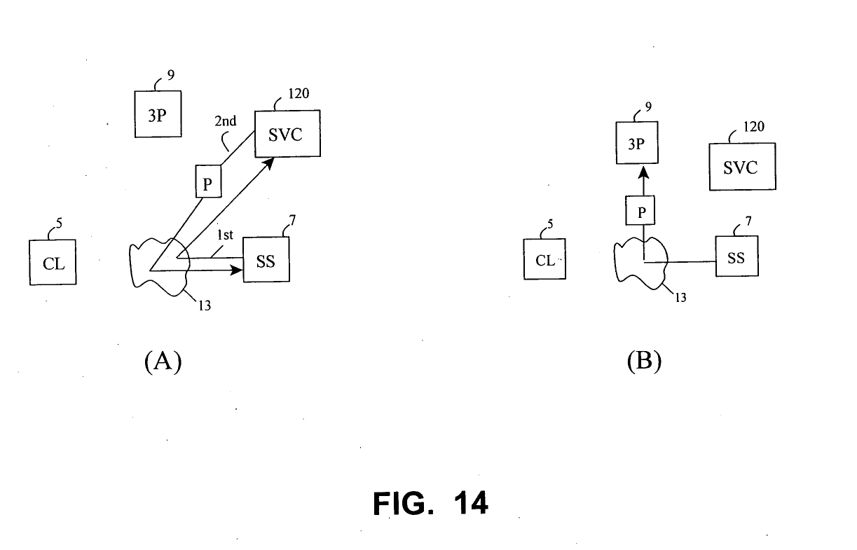

In FIGS. 13A, B and C, the scheduling service may actually first inquire (?) of a third party 9 to ascertain whether they have appropriate credentials before any delivering of the payload P takes place. Upon proper presentation of a token T or other authentication certificate, the scheduling service delivers the payload to the third party. Of course, the authentication may also occur relative to the client if the payload is going to the client or, if the client desires a last approval before delivery, such as upon a lengthy passage of time between job scheduling and payload delivery, the final authentication may come from the client while the payload still goes to the third party. Corresponding to this, optional step 116, FIG. 8, shows the authentication of recipients between steps 112 and 114.

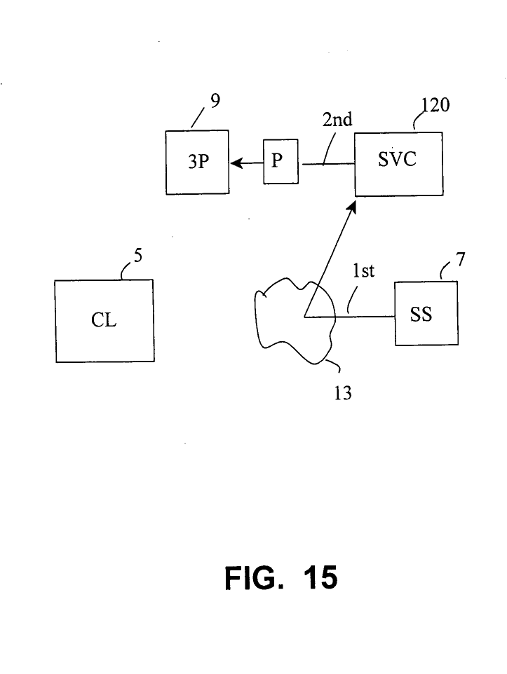

In FIGS. 14A and B, it may the situation that the payload itself does not reside with the scheduling service or the situation that the payload cannot be developed by the scheduling service. Thus, optional step 118, FIG. 8, invokes the development or seeking of the payload from still another party or service. Upon this occurring, the service 120 returns the payload to the scheduling service 7 where it is then forwarded to the third party recipient 9. Alternatively, FIG. 15 shows this as invoking the service 120, but delivery of the payload P goes directly to the third party 9 and not back to the scheduling service. In practice, this is particularly suited for the earlier genome sequencing example, whereby national genome databases of the federal government would act as the service 120. Of course, all features of the embodiments can be interchanged with one another to arrive at still other embodiments.

### EXAMPLE

In a representative scenario of the invention, a workflow is designed to give a user access to an Oracle database, but policy requires that the user renew his account every 90 days. The user is to be notified of imminent password expiration at the 60^{th}, 75^{th}, and 89^{th} days. On the 90th day, his account must expire.

On the “approved” branch of the workflow is an activity that schedules the execution of a repeating or renewal job.

The runtime scenario includes these events:

1. The workflow engine creates an instance of a provisioning flow based on a user request. The flow is officially active.

2. The engine creates its own key or keys for the workflow instance that include a GUID or other unique identifier, a timestamp, and any identity tokens or governance artifacts (or hashes derived therefrom) that the engine sees fit to craft.

3. Upon reaching the “schedule the Renewal job” node of the flow graph, the engine encodes state information about the flow (which MAY include the initiator DN, the approver DN, various e-mail addresses, the aforementioned key or keys, and/or other pieces of flow instance data) in XML, and optionally encrypts the XML. This is the userData XML.

4. The engine creates XML containing the actual parameter data for the scheduler service. This includes an array of time intervals, all relative to a certain date (the starting date of the user's Oracle access). The intervals are 0, 60, 75, 89, and 90. One or more addresses are associated with the respective intervals. Also, zero or more XPath expressions are associated with each.

5. The engine creates an account with the scheduler service under the workflow instance's identity. The service sends back a “receipt” or confirmation containing the account credentials.

6. The credentials are deposited in a place where an administrator identity can get to them if necessary.

7. The engine logs into the account and posts the job request (via SOAP). The caller receives a receipt. (This, too, is deposited somewhere.)

8. The scheduler service un-marshals everything and notices that the first pingback has a deadline of zero. It obtains the address(es) associated with that event and also the XPath expressions (and the bindings between the two). It runs each XPath query against the userData XML and sends the result to the appropriate addressee. One possible result is that at deadline zero (i.e., when the job is created), an e-mail is sent to the system admin saying “User cn-jdoe,ou=sales,ou=acme has received credentials for Oracle and the scheduler has scheduled a first renewal notice for 18 Mar. 2007.”

At 60 days, the scheduler runs new XPath queries and sends an e-mail to the user reminding him to renew within 30 days. It also posts an XPath:userData query result to an RSS server or message queue that is monitored by an administrative process.

At 75 days, the same events as the day 60 events occur, but with a reminder to renew within 15 days.

At 89 days, the same events as the day 60 events occur, but with a reminder to renew today, and including an extra log event and e-mail to the user's boss or manager indicating failure of the user to renew his Oracle account after two reminder notices.

At 90 days, the scheduling service sends a particular piece of parsed userData to a particular URL or URI, which causes an event that ultimately leads to deactivation of the user's Oracle account. The scheduler also sends e-mail to the system administrator that the user's Oracle account should by now be inactive.

### End Example

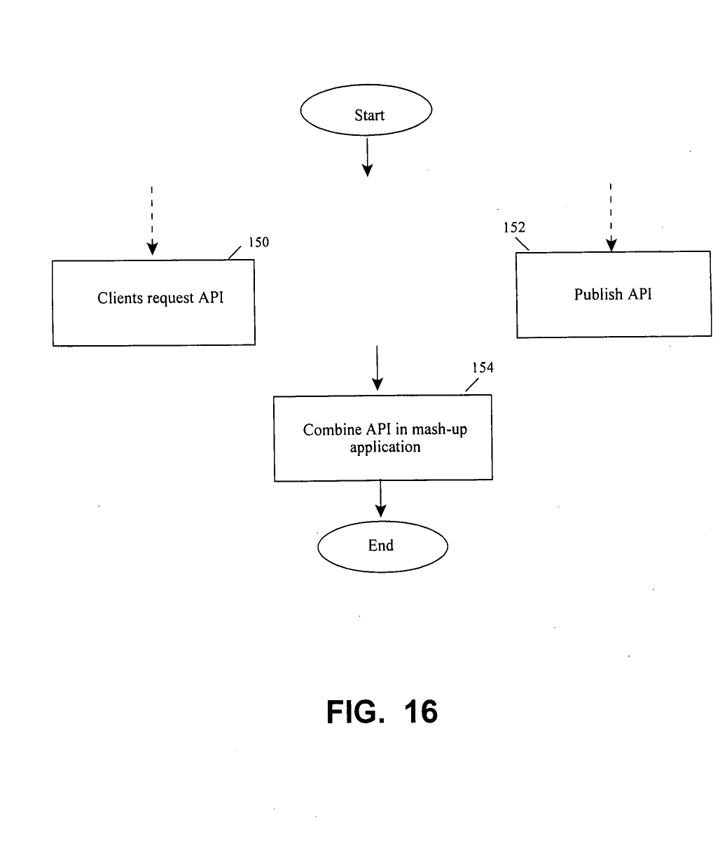

In FIG. 16, it is appreciated that a scheduling service will have greater applicability if it too can be involved in a mash-up application with other services or applications, such as is the situation presently with the Google Earth mapping software. Thus, upon either step 150 (clients requesting the API of the scheduling service) or step 152 (discovery of a published version of the API), the API is combined in a mash-up application, step 154.

In a representative embodiment, the API is (in at least one embodiment) expressed in WSDL and published to a service registry. Clients who need a scheduling service can thus discover the service (e.g., step 62, FIG. 3) and also discover what its communication modes, operations, messages, and expected interaction patterns are. The API is envisioned as being described as portTypes in the WSDL, or (alternatively, and in at least one embodiment) it is possible for the actual API or its extensions to be queried directly from the scheduling service.

It can be appreciated that services meeting these requirements can be exposed as SOAP endpoints or by other means, and data can be passed as XML or JSON payloads, and that payloads can be encrypted or not, and wire transmission can involve TLS or not, etc.

In another representative embodiment, the runtime executables that provide the core functionality might consist of Java classes in a JAR or WAR file deployed on a web server. (They could just as easily be C# classes running on Mono on a server, etc.) The classes in question could come from an open-source project such as Quartz.

An extra set of classes (also appropriately packaged, perhaps in the same WAR) would exist to provide a bridge between the core classes and the actual request-handler classes (e.g., servlets) that face the outside world, effectively translating API requests into method calls that the core objects can understand.

In at least one embodiment, the communication layer would handle requests via http, but it might also be able to “speak” JMS, SMP, or use protocols yet unknown. The preferred embodiment will at least handle http requests.

A representative embodiment would offer at least the following functionalities (exposed through a public API, defined, e.g., using WSDL).

| Method Name | Description |
|---|---|
| createAccount | Allows a client process to register with the service and obtain credentials. |
| registerJob | Allows a credentialed process to register a Job with the service. The caller gets |
| | back a key that must be used to access the Job later with getJobStatus (below). |
| | “Parameter” info passed to the service as part of job registration would include: |
| | a userData XML fragment (arbitrary as to content) |
| | pingback address(es) (which could be a URI or URL, an e-mail address, |
| | topic/queue address, or other address to contact at each scheduled event) |
| | fault notification address(es) |
| | level of service requirements (minimum acceptable timing resolution, other |
| | info) |
| | an ordered list of pingback deadlines (which can be relative or absolute |
| | dates/times). The latter can include just one value if the required action is of a |
| | “ping once only” nature. It can also include an interval and a repeat count (for |
| | pingbacks of a “heartbeat” nature). It can also include an ordered list of |
| | irregular intervals (in case the client wants to be contacted at 80 days, 89 days, |
| | and 90 days later). |
| | Instructions (such as an ordered array of XPath or XQuery expressions) telling |
| | which portions of userData to query at each pingback time. |
| | XPath-to-address bindings so that the scheduler knows which XPath query |
| | results to send to which address, at pingback time. |
| getJobStatus | Allows a credentialed process to query the service for information about a job. |

As a result, certain advantages of the invention over the prior art are readily apparent. For example, it is heretofore unknown to promote job scheduling to a position of first-class citizenship in an SOA architecture and (in doing so) make scheduled processes more governanceable, which is to say, make it possible to log, track, audit, attest to, policy-control, and administer time-domain aspects of processes in a standard way across the enterprise. It is also unknown before now to promote scheduling to a higher level of abstraction so as to decouple the scheduler implementation (and its platform dependencies) from the public-facing API, such that a scheduler can be written in any language, on any machine, and yet still used by any client in accordance with the published API. Still further advantages include, but are not limited to: the promotion of scheduling code reuse; the elimination of unnecessary intimacy between applications, components, containers, frameworks, and connected systems at the enterprise level, thereby eliminating hard-to-predict side effects in the course of system evolution; the registering of jobs with a scheduler in a secure way and passing encrypted data to the scheduler for later reuse by the client or other recipient; the monitoring or tracking of job events, such as by an administrator subscribing (in identity-managed way) to an RSS or Atom feed; the facilitating the use of schedulers as first-class entities in a message bus or enterprise service bus (ESB) environment; and the enabling of AJAX components and web applications to leverage externally supplied job scheduling functionality in so-called “mashups.”

Finally, one of ordinary skill in the art will recognize that additional embodiments are also possible without departing from the teachings of the present invention. This detailed description, and particularly the specific details of the exemplary embodiments disclosed herein, is given primarily for clarity of understanding, and no unnecessary limitations are to be implied, for modifications will become obvious to those skilled in the art upon reading this disclosure and may be made without departing from the spirit or scope of the invention. Relatively apparent modifications, of course, include combining the various features of one or more figures with the features of one or more of other figures.

1. In a computing system environment having a computing device arranged together per each of a client and a scheduling service, a method of scheduling time-based services, comprising:
by the client, creating an account with the scheduling service based on an identity of the client;
by the client, registering a time-based scheduling job with the scheduling service including indicating a location of delivery for a payload upon arrival of a time occasion;
by the scheduling service, determining whether the time occasion of the registered scheduling job has arrived; and
if arrived, delivering the payload to the location indicated.

2. The method of claim 1, further including indicating individual identities and rights of the client.

3. The method of claim 1, further including determining appropriate communication channels between the client and the scheduling service and third parties, if any.

4. The method of claim 1, further including establishing encryption or authentication tools.

5. The method of claim 1, further including indicating to the scheduling service a content of the payload.

6. The method of claim 1, wherein the registering the scheduling job further includes scheduling queries.

7. The method of claim 1, wherein the registering the scheduling job further includes caching the location and the time occasion.

8. The method of claim 1, wherein the delivering the payload further includes authenticating a recipient at the location.

9. The method of claim 1, wherein the delivering the payload further includes delivering the payload to a third party, including noticing the client.

10. The method of claim 1, wherein the delivering the payload further includes launching a third party service before the delivering the payload.

11. The method of claim 1, further including publishing an API of the scheduling service for use in mashing-up applications.

12. The method of claim 1, further including monitoring the registered scheduling job by the identity of the created account.

13. In a computing system environment having a computing device arranged together per each of a client and a scheduling service, a method of scheduling time-based services useful to an underlying application, comprising:
by the client, creating an account with the scheduling service indicating individual identities and rights for use with a time-based scheduling job, the scheduling service having no unnecessary entanglement with the underlying application using the scheduling job;
by the client, registering the scheduling job with the scheduling service including indicating a location of delivery for a payload upon arrival of a time occasion;
by the scheduling service, determining whether the time occasion of the registered scheduling job has arrived; and
if arrived, delivering the payload from the scheduling service to the location indicated.

14. The method of claim 13, further including determining appropriate communication channels between the client and the scheduling service and third parties, if any.

15. The method of claim 13, further including establishing encryption or authentication tools.

16. The method of claim 13, further including establishing the scheduling service on a web server reachable by the client engaged in an http session.

17. The method of claim 13, wherein the delivering the payload further includes authenticating a recipient of the payload at the indicated location.

18. The method of claim 13, wherein the delivering the payload further includes delivering the payload to a third party, including noticing the client.

19. The method of claim 13, wherein the delivering the payload further includes launching a third party service before the delivering the payload.

20. The method of claim 13, further including publishing an API of the scheduling service for use in a mashing-up application.

21. The method of claim 13, further including monitoring the registered scheduling job by one of the individual identities according to the rights of the created account.

22. In a computing system environment having a computing device arranged per each of a client and a scheduling service, a method of scheduling time-based services, comprising: engaging an http session between the client and the scheduling service;
indicating identities and rights of the client for use with a time-based scheduling job;
registering the scheduling job with the scheduling service including indicating a location of delivery for a payload at a time occasion;
periodically checking whether the time occasion of the registered scheduling job has arrived;
by the individual identities according to the indicated rights, monitoring the registered scheduling job; and
if the time occasion has arrived, delivering the payload from the scheduling service to the location indicated.

23. The method of claim 22, further including establishing appropriate communication channels between the client and the scheduling service and third parties, if any.

24. The method of claim 22, wherein the delivering the payload further includes authenticating a recipient of the payload at the indicated location.

25. The method of claim 22, wherein the delivering the payload further includes delivering the payload to a third party, including noticing the client.

26. The method of claim 22, wherein the delivering the payload further includes launching a third party service before the delivering the payload.

27. The method of claim 22, wherein the monitoring further includes subscribing to a message bus.

28. The method of claim 22, wherein the monitoring further includes visiting an electronic bulletin board.

29. The method of claim 29, further including interposing an intermediary party between the client and the scheduling service for coordinating communications between the client and the scheduling service.
